(19) United States
(12) Patent Application Publication
(10) Pub. No.: US 2020/0178468 A1
(43) Pub. Date: Jun. 11, 2020

(54) COMBINE HARVESTER

(71) Applicant: AGCO International GmbH, Neuhausen (CH)

(72) Inventor: Frederic Ducroquet, Châteaubriand (FR)

(21) Appl. No.: 16/709,834

(22) Filed: Dec. 10, 2019

(30) Foreign Application Priority Data
Dec. 10, 2018 (GB) 1820059.2

(51) Int. Cl. A01F 12/44

(52) U.S. Cl. CPC A01F 12/444; A01F 12/446

(57) ABSTRACT

A fan unit for a combine harvester cleaning unit having at least two fan wheels, each fan wheel being enveloped by a fan wheel housing having at least one inlet segment and at least one outlet segment extending tangentially from the fan wheel housing, each outlet segment being connected to a common channel section and each vertical side wall of an outlet segment adjacent another outlet segment is inclined toward the vertical side wall of the adjacent outlet segment. This construction has as an advantage that it allows for improved flow characteristics of the air exiting the outlet thereby permitting better separation of MOG and grain in the sieves of the cleaning unit of which the fan unit is a part.

### FIELD

The invention relates to combine harvesters and particularly to systems for transferring crop material from threshing and separating apparatus to a grain cleaning unit. More specifically the invention relates to a cleaning fan for a combine harvester conveyance system which includes grain pans arranged to catch a crop stream, the grain pans being driven in an oscillating manner to convey the crop stream rearwardly to a grain cleaning unit.

### BACKGROUND

The process for cleaning grain in combine harvesters has not changed fundamentally for many decades. A cleaning unit, or ‘shoe’, has a cleaning airstream directed through it. The cleaning airstream may be generated by a cross-flow or centrifugal fan located in front of the cleaning shoe. As a mix of grain kernels, chaff, tailings and straw is passed over one or more oscillating sieves, the cleaning airstream serves to blow the lighter material in a generally rearward direction over the sieves and out of the rear of the machine. The grain is generally heavier and/or smaller than the material other than grain (MOG) in the mix and passes through the sieves.

The cleaning unit typically comprises a housing having a chaffer at an upper surface. A fan unit is disposed at one end of the cleaning unit, an outlet of the fan unit being connected at one end of the cleaning unit between the housing and a first end of the chaffer. A lower sieve is located below the chaffer within the housing. A lower part of the housing is provided with a clean grain trough in which an auger or screw conveyor is disposed in order to transport the separated grain towards storage in an on board tank.

It is known to provide a fan unit for this purpose comprising a number of fan wheels adapted to be driven about a shaft, at least one housing section enveloping the fan wheels. The housing has at least one inlet opening for drawing in air. The housing further comprises an outlet segment extending in a tangential direction, and a channel section adjoining the outlet segments. Within the outlet segment are provided parallel walls connected by vertically oriented, substantially U-shaped wall sections. The arcuate shape of the wall sections connecting the parallel legs promotes the flow around the air flow to immediately adjacent air outlet sections. However, it also the case that this flow swirls in the walled sections such that “dead zones” are created in the air flow from the channel section toward the sieves.

It is an advantage of the present invention that such dead zones are eliminated or at least substantially reduced.

### BRIEF SUMMARY

According to a first aspect of the present invention, a fan unit for a cleaning unit comprises at least two fan wheels, each fan wheel being enveloped by a fan wheel housing having at least one inlet segment and at least one outlet segment extending tangentially from the fan wheel housing, each outlet segment being connected to a common channel section characterised in that each vertical side wall of an outlet segment adjacent another outlet segment is inclined toward the vertical side wall of the adjacent outlet segment.

Preferably each vertical side wall of the outlet segment adjacent another outlet segment is inclined toward the vertical side wall of the adjacent outlet segment at angle between 5 and 20 degrees.

Preferably upper and lower walls of each outlet segment are curved away from a tangent extending away from the fan wheel housing.

More preferably, the lower wall of each outlet segment presents a concave surface to the tangent.

According to a second aspect of the present invention, a fan unit for a cleaning unit comprises at least two fan wheels, each fan wheel being enveloped by a fan wheel housing having at least one inlet segment and at least one outlet segment extending tangentially from the fan wheel housing, each outlet segment being connected to a common channel section characterised in that upper and lower walls of each outlet segment are curved away from a tangent extending away from the fan wheel housing.

More preferably, the lower wall of each outlet segment presents a concave surface to the tangent.

Each of the first and second aspect of the invention has as an advantage that it allows for improved flow characteristics of the air exiting the outlet. This in turn permits better separation of MOG and grain in the sieves of the cleaning unit of which the fan unit may form a part.

According to a third aspect of the present invention, a cleaning unit comprises a fan unit according to the first or second aspect of the invention.

According to a fourth aspect a harvester incorporates a cleaning unit according to a second aspect of the invention.

### BRIEF DESCRIPTION OF THE DRAWINGS

The invention will now be described, by way of example only, with reference to the accompanying drawings, in which:

FIG. 1 shows a schematic side view of an example combine harvester;

FIG. 2 shows a detail of FIG. 1;

FIG. 3 shows a schematic plan view in partial cutaway of a known air blowing apparatus;

FIG. 4 shows a schematic plan view in partial cutaway of an air blowing apparatus for use in the present invention;

FIG. 5 shows a schematic view of the known air blowing apparatus of FIG. 3 illustrating air flow at an outlet of the air blowing apparatus;

FIG. 6 shows a schematic view of the air blowing apparatus of FIG. 4 illustrating air flow at an outlet of the air blowing apparatus;

FIG. 7 shows a simplified perspective side view of the blowing apparatus of FIGS. 3 and 5; and

FIG. 8 shows a simplified perspective side view of the blowing apparatus of FIGS. 4 and 6.

### DETAILED DESCRIPTION OF SPECIFIC EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Reference to terms such as longitudinal, transverse and vertical are made with respect to a longitudinal vehicle axis which is parallel to a normal forward direction of travel.

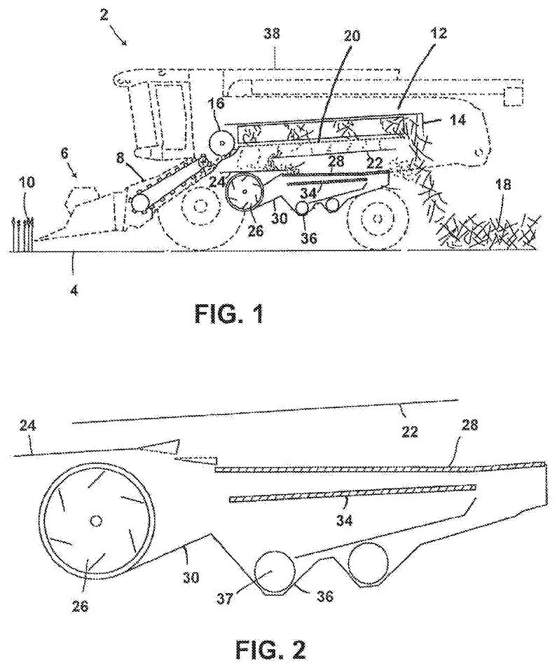

A known combine harvester 2 is shown by way of example in FIG. 1. The combine harvester 2 includes a frame, front wheels and rear steerable wheels, the wheels engaging with the ground 4 . A cutting header 6 is detachably supported on the front of a feederhouse 8 which is pivotable about a transverse axis to lift and lower the header 6 in a conventional manner. The header 6 serves to cut and gather crop material 10 before conveying such into the feederhouse 8 and an elevator housed therein.

The cut crop stream is conveyed rearwardly from the feederhouse 8 to a processor designated generally at 12. The processor of the illustrated combine includes an axial flow threshing and separating rotor 14 which is fed at its front end by a feed beater 16. The axial flow rotor 14 serves to thresh the crop stream in a front region, separate the grain therefrom in a rear region, and eject the straw residue 18 through the rear of the machine either directly onto the ground in a windrow or via a straw chopper (not shown). A grate 20 in the underside of the threshing and separating rotor allows the separated material to fall by gravity onto a return pan 22 located below.

At this stage in the process a mix of grain, kernels, chaff, un-threshed tailings and shorter straw have been separated from the majority of the straw residue, the separated mix having fallen through the grate 20 of processor 12 onto the return pan 22. The remaining straw residue continues to the rear from where it is discharged onto the ground in a windrow.

The grain-MOG mix falls onto a grain pan 24. The grain-MOG mix is conveyed in a generally rearward direction towards a grain pan rear edge from where the mix falls onto the front of a top sieve or chaffer 28.

As the grain-MOG mix falls from the grain pan rear edge it is subjected to a cleaning airstream generated by fan unit 26 which includes a cross-flow fan in a fan housing 30. Ducting directs the pressurised air under the grain pan rear edge, the airstream serving to blow the MOG upwardly and rearwardly towards the rear of the machine.

A lower sieve 34 is also driven in an oscillating manner to convey the collected grain-MOG mix rearwardly wherein the material falling therethrough is collected in a clean grain trough 36 for transport by a conveying auger 37 and conveyance by an elevator to a grain tank 38. Material which does not pass through the lower sieve 34 and is instead conveyed off the rear edge thereof falls into a re-threshing region for subsequent re-threshing in accordance with known principles.

The airstream generated by the fan unit 26 is also directed by the ducting up through the lower sieve 34 and chaffer 28 to encourage lifting of the MOG from the chaffer surface. For ease of reference hereinafter the chaffer 28, lower sieve 34, and the fan unit 26 will be collectively referred to as “the cleaning shoe”. Moreover, the return pan 22 and grain pan 24 will be referred to as “the crop material transfer system” which serves the purpose of transferring the material separated by the processor to the cleaning shoe.

The above described operating principle of a combine harvester, and in particular the flow of crop material therethrough, is known in the art.

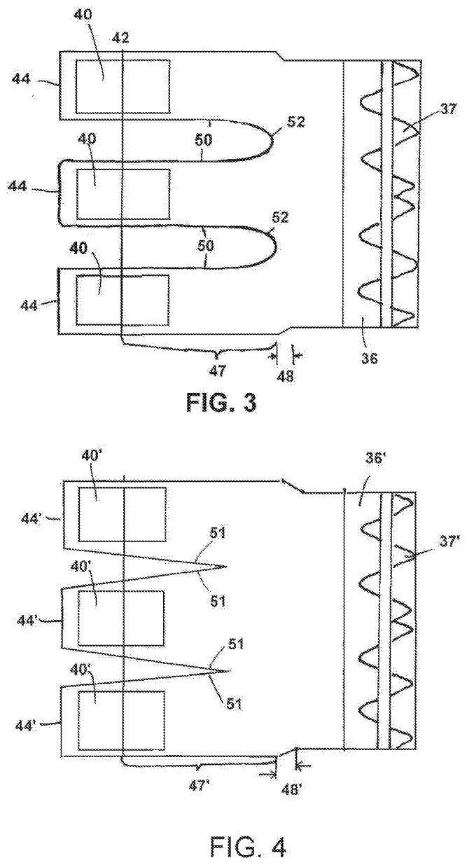

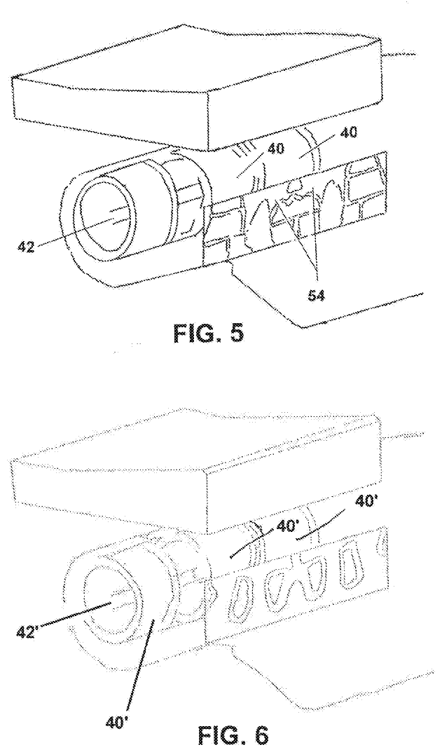

FIGS. 3, 5 and 7 show in more detail a known construction of transverse, air blowing apparatus forming part of a cleaning shoe. A number of fan wheels 40 are shown adapted to be driven about a rotational axis 42. The fans may for example be mounted on a common rotational shaft. With respect to the cleaning shoe, forward air flow is from the fan wheels towards the sieve assembly. References to ‘upstream’ or ‘downstream’ should be interpreted accordingly. A housing section 44 envelopes each of the fan wheels 40. Each housing section 44 has at least one inlet opening 46 for drawing in air.

Each housing section 44 further comprises an outlet segment 47 extending in a tangential direction from a lower surface of housing section 44. A common channel section 48 joins each of the tangentially extending outlet segments 47. The outlet segments 47 are provided with vertically oriented substantially parallel side walls 50. The parallel walls 50 of one housing section 44 are connected to the parallel walls 50 of an adjacent housing section 44 by vertically oriented, substantially U-shaped wall sections 52 to provide a transition to the channel section 48. The arcuate shape of the wall sections 52 connecting the adjacent outlet segments allows air flow to immediately adjacent air outlet sections. However, it also the case that this flow swirls in the channel section 48 such that “dead zones” 54 (that is zones of significantly reduced air flow) within otherwise normal airflow can be created within the channel section 48 and the cleaning shoe ducting downstream of the sieve. Such ‘dead zones’ impair efficient operation of the cleaning shoe.

Similar references are used to refer to similar parts throughout.

FIGS. 4, 6 and 8 relate to a construction of a transverse, air blowing apparatus 24′ according to the present invention. As in the prior art, a number of fan wheels 40′ are shown adapted to be driven about a common axis of rotation, with a housing section 44′ enveloping the fan wheels 40′. Again, each housing section 44′ has at least one inlet opening 46′ for drawing in air. Also, the housing section 44′ again further comprises an outlet segment 47′ extending in a tangential direction, and a channel section 48′ adjoining the outlet segments 47′ for connection to the cleaning unit housing.

However, in the invention two principal differences from the prior art may be noted.

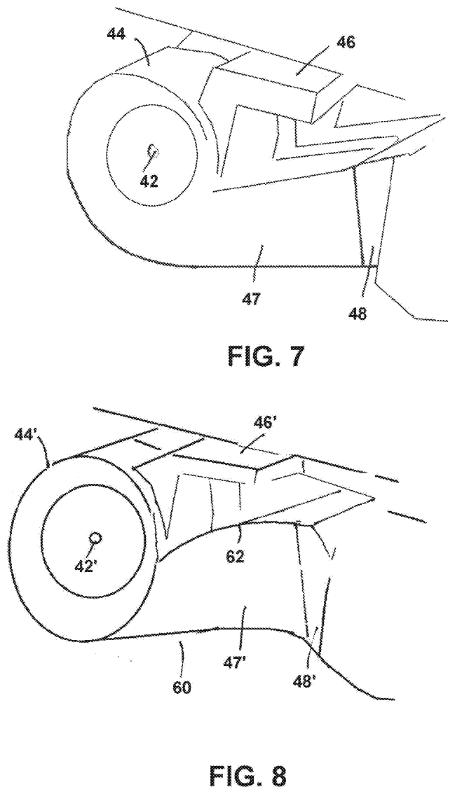

In a first aspect, best seen in FIG. 4 the side walls of the adjacent outlet segments 46′ are no longer parallel to one another. Instead the side walls 51 of the adjacent side walls 51 are substantially uniformly inclined toward one another. Conveniently this angle may be between 5 and 20 degrees. Each side wall 51 extends from a point downstream of the fan wheel 40′ and extends toward an adjacent side wall 51. The angle is such that the outlet segments 47′ are joined ahead of the channel section 48′ (FIG. 4 and FIG. 7). This allows the flow of air to expand laterally and reduces the tendency to swirl.

In a second aspect, although the outlet segments 46′ extend tangentially from the housing section, as is best seen in FIG. 8, a lower surface 60 of each outlet segment 46′ curves away from the tangent presenting a concave face to the tangent. Similarly, while in the prior art of FIG. 7 an upper surface of the outlet segment 47′ is substantially linear, in the present invention, the upper surface 62 ‘is curved, shadowing the curvature of the lower surface 60. This curved shaping of the upper and lower surfaces 60,62 of the outlet segments 46’ also reduces the tendency of the flow of air to swirl.

When both aspects are utilised, the flow of air though the cleaning shoe is greatly enhanced.

From reading the present disclosure, other modifications will be apparent to persons skilled in the art. Such modifications may involve other features which are already known in the field of cleaning fans for a combine harvester and component parts therefore and which may be used instead of or in addition to features already described herein.

1. A fan unit for a cleaning unit comprising at least two fan wheels, each fan wheel being enveloped by a fan wheel housing having at least one inlet segment and at least one outlet segment extending tangentially from the fan wheel housing, each of the at least one outlet segments being connected to a common channel section wherein each vertical side wall of an outlet segment adjacent another outlet segment is inclined toward the vertical side wall of the other outlet segment.

2. The fan unit according to claim 1, wherein each vertical side wall of the outlet segment adjacent another outlet segment is inclined toward the vertical side wall of the other outlet segment at an angle between 5 and 20 degrees.

3. The fan unit according to claim 1, wherein upper and lower walls of each outlet segment are curved away from a tangent extending away from the fan wheel housing.

4. The fan unit assembly according to claim 3, wherein the lower wall of each outlet segment comprises a concave surface to the tangent.

5. The fan unit for a cleaning unit comprising at least two fan wheels, each fan wheel being enveloped by a fan wheel housing having at least one inlet segment and at least one outlet segment extending tangentially from the fan wheel housing, each outlet segment being connected to a common channel section wherein an upper and a lower wall of each outlet segment are curved away from a tangent extending away from the fan wheel housing.

6. The fan unit according to claim 5, wherein the lower wall of each outlet segment presents a concave surface to the tangent.

7. A cleaning unit for a combine harvester comprising the fan unit according to claim 1.

8. A combine harvester comprising the cleaning unit according to claim 7.
